(19) United States
(12) Patent Application Publication
(10) Pub. No.: US 2025/0121952 A1
(43) Pub. Date: Apr. 17, 2025

(54) AUTONOMOUS WIRELESS TRANSFER OF FLIGHT RECORDER DATA WITHOUT AIRCRAFT MODIFICATION

(71) Applicant: L3 Technologies, Inc., Melbourne, FL (US)

(72) Inventors: John S. Patrick, Venice, FL (US); Eduardo Manuel Carro, Sarasota, FL (US); William N. Waggener, JR., Sarasota, FL (US); Eric R. Francis, Westerville, OH (US)

(21) Appl. No.: 18/486,555

(22) Filed: Oct. 13, 2023

(51) Int. Cl. B64D 45/00; H04L 67/125

(52) U.S. Cl. CPC B64D 45/00; H04L 67/125; B64D 2045/0065

(57) ABSTRACT

A method of flight data transmission by a flight data recorder of an aircraft includes receiving flight data from a Flight Data Acquisition Unit (FDAU); storing the flight data in a Crash Survivable Memory Unit (CSMU); storing the flight data in a temporary memory; determining, based on a first one or more flight data parameters included in the flight data, whether conditions are met for wireless transfer of the flight data; determining, based on a second one or more of the flight data parameters, an appropriate medium and mode for transmission of the flight data; and wirelessly transmitting the flight data using the appropriate medium and mode.

### BACKGROUND

### 1. Field

Example embodiments relate to transmission of flight data, and more specifically, to autonomous wireless transmission of flight data.

### 2. Description of Related Art

Commercial and military aircraft typically include an aircraft recorder, sometimes called a “black box,” which stores data related to the current flight of the aircraft. The aircraft recorder may be a flight data recorder (FDR), a cockpit voice recorder (CVR), or a combination voice and data recorder, such as a cockpit voice and data recorder (CVDR). The recorded data may be used to analyze aircraft crashes and other incidents. Thus, FDRs, CVRs, and CVDRs often function as a repository of all the data pertinent to the functionality of an aircraft. Such data is commonly recorded, with the FDR, CVR, and/or CVDR having no knowledge of its content. Non-crash survivable data recorders, including Quick Access Recorders (QARs), may also store such data in small and portable removable media, such as a Secure Digital (SD) card, for example.

FDRs and QARs typically receive data via an ARINC 717 or other avionics data busses and store it in nonvolatile memory. The data is then retrieved for analysis when the aircraft lands for maintenance purposes or after an incident. The recorder does not process this data in any way, but stores it raw, possibly with headers for time stamping. Thus, a stream of bits is received and recorded, but not decoded or utilized except after a flight is completed, or an emergency has occurred.

In order for the data to be retrieved, there must be some type of operator interaction. Typically, either an operator must physically remove a memory module, or use a piece of ground equipment to download the data. There are some wireless download systems, though these still require operator intervention, e.g. by an operator pushing a button or switch, selecting a download function, or otherwise physically interacting with the FDR. Such systems also require additional or modified hardware.

As such a data download is a non-flight critical action, air crew will only initiate when it is safe to do so, which may be some time after it is possible for the connection to be initiated and the download to happen.

Furthermore, as data transfer is not instantaneous and can take several minutes, it is possible that by the time an air crew has initiated a wireless transfer, that there is not sufficient time for the transfer to be completed prior to the aircraft being powered down. This results in either the aircraft being powered down and the transfer interrupted, or the aircraft power being kept on longer than otherwise required.

### SUMMARY

Example embodiments may address at least the above problems and/or disadvantages and other disadvantages not described above. Also, example embodiments are not required to overcome the disadvantages described above, and may not overcome any of the problems described above.

According to an aspect of an example embodiment, a method of flight data transmission by a flight data recorder (FDR) of an aircraft comprises: receiving, from a Flight Data Acquisition Unit, a data stream comprising flight data comprising a plurality of flight data parameters; storing the plurality of flight data parameters in a Crash Survivable Memory Unit; storing the plurality of flight data parameters in a temporary memory; determining, based on a first one or more of the plurality of flight data parameters, that conditions are met for wireless transfer of the flight data; determining, based on a second one or more of the plurality of flight data parameters, an appropriate medium and mode for transmission of the flight data; wirelessly transmitting the flight data using the appropriate medium and mode.

The plurality of flight data parameters may comprise at least one of air speed, altitude, vertical acceleration, time, magnetic heading, control-column position, rudder-pedal position, control-wheel position, wing flap position, fuel flow, landing gear position, and groundspeed.

The determining that conditions are met for wireless transfer may comprise: determining that the aircraft has been in flight; the left-and right-main wheels have transitioned to on-ground; and determining that airspeed has decreased below a predetermined speed.

The wirelessly transmitting may comprise determining that a first wireless transmission is not completed and retransmitting the flight data using the appropriate medium and mode.

The appropriate medium and mode for transmission of the flight data may be one of WiFi, WiMax, cellular radio transmission, and satellite transmission.

The method may further comprise, upon determining that the wireless transmission is completed, outputting an indication of completion.

According to an aspect of another example embodiment, a flight data recorder (FDR) system of an aircraft comprises: a housing a system interface operatively coupled to a Flight Data Acquisition Unit to thereby receive a data stream comprising flight data comprising a plurality of flight data parameters; a Crash Survivable Memory Unit storing therein the one or more flight data parameters received in the flight data stream; a wireless transmitter under exclusive control of the FDR system; a non-volatile memory storing thereon computer-readable instructions; a processor configured to execute the instructions stored on the non-volatile memory and to thereby perform a method comprising: determining, based on a first one or more of the plurality of flight data parameters, that conditions are met for wireless transfer of the flight data; determining, based on a second one or more of the plurality of flight data parameters, an appropriate medium and mode for transmission of the flight data; controlling the wireless transmitter to transmit the flight data using the appropriate medium and mode.

The plurality of flight data parameters may comprise at least one of air speed, altitude, vertical acceleration, time, magnetic heading, control-column position, rudder-pedal position, control-wheel position, wing flap position, fuel flow, landing gear position, and groundspeed.

The determining that conditions are met for wireless transfer may comprise: determining that the aircraft has been in flight; the left- and right-main wheels have transitioned to on-ground; and determining that airspeed has decreased below a predetermined speed.

The controlling the wireless transmitter to transmit may comprise determining that a first wireless transmission is not completed and controlling the wireless transmitter to retransmit the flight data using the appropriate medium and mode.

The appropriate medium and mode for transmission of the flight data may be one of WiFi, WiMax, cellular radio transmission, and satellite transmission.

The processor may be further configured to control output of an indication of completion, upon a determination that the wireless transmission is completed.

According to an aspect of another example embodiment, an aircraft comprises: a flight data recorder (FDR) system comprising: a housing a system interface operatively coupled to a Flight Data Acquisition Unit to thereby receive a data stream comprising flight data comprising a plurality of flight data parameters; a Crash Survivable Memory Unit storing therein the one or more flight data parameters received in the flight data stream; a wireless transmitter under exclusive control of the FDR system; a non-volatile memory storing thereon computer-readable instructions; a processor configured to execute the instructions stored on the non-volatile memory and to thereby perform a method comprising: determining, based on a first one or more of the plurality of flight data parameters, that conditions are met for wireless transfer of the flight data; determining, based on a second one or more of the plurality of flight data parameters, an appropriate medium and mode for transmission of the flight data; controlling the wireless transmitter to transmit the flight data using the appropriate medium and mode.

The plurality of flight data parameters may comprise at least one of air speed, altitude, vertical acceleration, time, magnetic heading, control-column position, rudder-pedal position, control-wheel position, wing flap position, fuel flow, landing gear position, and groundspeed.

The determining that conditions are met for wireless transfer may comprise: determining that the aircraft has been in flight; determining that the left-and right-main wheels have transitioned to on-ground; and determining that airspeed has decreased below a predetermined speed.

The controlling the wireless transmitter to transmit may comprise determining that a first wireless transmission is not completed and controlling the wireless transmitter to retransmit the flight data using the appropriate medium and mode.

The appropriate medium and mode for transmission of the flight data may be one of WiFi, WiMax, cellular radio transmission, and satellite transmission.

The processor may be further configured to control output of an indication of completion, upon a determination that the wireless transmission is completed.

The aircraft may further comprise an essential electrical bus operatively coupled to the FDR which can only be shut down under flight conditions when other equipment that is essential for safe flight operations is also disabled.

### BRIEF DESCRIPTION OF THE DRAWINGS

The above and/or other aspects will become apparent and more readily appreciated from the following description of example embodiments, taken in conjunction with the accompanying drawings, in which:

FIG. 1 is a perspective view of a commercial aircraft according to an example embodiment;

FIG. 2 is a detailed block diagram of a Flight Data Recorder according to an example embodiment; and

FIG. 3 is a flowchart of a method of wireless transmission of flight data according to an example embodiment.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described here in detail.

Most commercial and military aircraft, as well as many civilian aircraft, carry Flight Data Recorders (FDRs) and/or Cockpit Voice Recorders (CVRs). During normal flight operations, the FDR records specific aircraft performance parameters, such as air speed, altitude, vertical acceleration, time, magnetic heading, control-column position, rudder-pedal position, control-wheel position, horizontal stabilizer, and fuel flow. The CVR records cockpit voices and other audio such as conversations between ground control and flight crew. Each of the recorders has an enclosure containing an electronic interface, processing circuits and a Crash Survivable Memory Unit (CSMU). The CSMU contains non-volatile memory for storing the flight data and voice data. A CVR can have a Recorder Independent Power Supply (RIPS) which provides a backup power source in the event that standard aircraft power is interrupted or lost. In some applications, an FDR and a CVR can be combined into a single device (i.e. a Cockpit Voice and Data Recorder or (CVDR)) which performs both functions. For convenience, example embodiments will be described herein with respect to an FDR, but it should be understood that the example embodiments may also apply to a CVR, CVDR, QAR, Airborne Image Recorder (AIR) or other flight recorder. Accordingly, all references to an FDR should be understood to include a CVR, CVDR, QAR, AIR, or other flight recorder.

In order to prevent the flight crew from disabling the wireless access device used by the FDR, such equipment can be exclusively under the control of the FDR. Moreover, such wireless access device may be embedded, attached to, or otherwise integrated with the FDR so that it is difficult to access by flight crew and others during flight. An FDR is usually located in the tail of the aircraft and is difficult to shut down since it must be powered from an essential electrical bus. Accordingly, the wireless access device can be protected from tampering during flight by ensuring that it is also powered from such essential electrical bus. This can be accomplished by providing power to the wireless access device directly from the same essential electrical bus as is used for the FDR. Alternately, primary electrical power to the wireless access device can be provided from the essential electrical bus via the FDR. For example, the wireless access device may be powered by a common power supply used to power the FDR. In such case, the dedicated wireless access device could not be shut down without also powering down the FDR.

The wireless access device for the FDR can be any suitable equipment capable of carrying out the data communication tasks described herein. According to one aspect, the wireless access device may include a transmitter configured for satellite radio communications. The wireless access device may be designed to use any suitable satellite communication protocol, including, but not limited to short burst communications. As an alternative or addition to the foregoing, the wireless access device can comprise cellular radio equipment, WiFi (based on IEEE 802.11 standard) or WiMax (based on IEEE 802.16 standard) type wireless access device, or other high-speed wireless data communication, as would be understood by one of skill in the art.

In order to determine when the data is to be transmitted, one or more parameters can be extracted from a conventional data stream which is communicated to an FDR. These parameters can be evaluated to determine if the aircraft is on the ground or otherwise in a position to transmit the data to ground equipment, or if another a transmission condition exists that would warrant activating the wireless access device as described herein. Example parameters used to determine if the aircraft is on the ground or in a position to transmit to ground equipment may include, but are not limited to, airspeed, landing gear down, and landing gear weight on wheels. Other parameters which may be considered include angle of attack, radar altitude, latitude and longitude, and engine throttle or speed. Information of these parameters may be included in the data stream received by the FDR from the aircraft. Accordingly, transmission of the data may be determined, without operator intervention, by accessing the data stream received by the FDR.

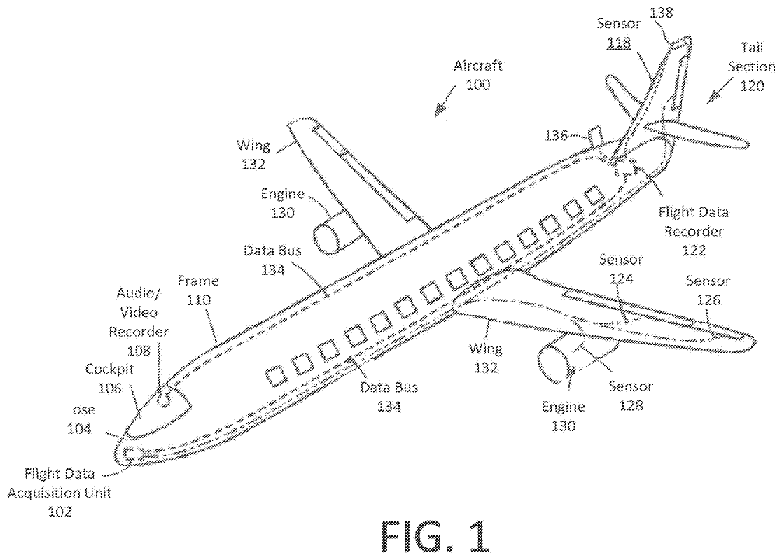

Referring now to FIG. 1, there is provided a perspective view of a commercial aircraft according to an example embodiment. The aircraft 100 is generally a vehicle that is able to fly by being supported by air. The aircraft 100 counters the force of gravity by using the thrust from engines. In the example embodiment shown, the aircraft 100 comprises a nose section 104, a cockpit 106, a fuselage or airframe 110, a tail section 120, wings 132 and engines 130. However, example embodiments are not intended to be limited to fixed wing aircraft, and can be utilized in any other type of aircraft as well, including rotor craft.

A Flight Data Acquisition Unit (FDAU) 102 is positioned in the nose section 104 of the aircraft 100 to acquire flight information from corresponding sensors located throughout the aircraft 100. Such flight information can include, but is not limited to, air speed, altitude, vertical acceleration, time, magnetic heading, control-column position, rudder-pedal position, control-wheel position, wing flap position, horizontal stabilizer, fuel flow and landing gear position. FDAUs 102 are well known in the art, and therefore will not be described in detail herein.

Sensors are placed on critical surfaces and system components of the aircraft 100 to convert real-time physical flight measurements into electrical signals for the FDAU 102. Typical aircraft sensors include an engine speed sensor 128, a wing flap position sensor 124, an aileron position sensor 126 and a rudder position sensor 118. The aircraft sensors 118 and 124-128 can be connected to the FDAU 102 through a fly-by-wire data bus 134 or wireless channel. The aircraft sensors 118 and 124-128 are well known in the art, and therefore will not be described in detail herein.

An Audio/Video Recorder (AVR) 108 is provided in the aircraft 100 to collect other flight related information, such as audio and video data. The AVR 108 can be located in the cockpit, passenger area, cargo hold or landing gear compartment of the aircraft 100. AVRs 108 are well known in the art, and therefore will not be described in detail herein.

The FDAU 102 and AVR 108 route flight related information to the FDR 122 via the data bus 134, a direct link, or a wireless transmission. The FDR 122 is mounted to the airframe 110, typically, but not necessarily, in the tail section of the aircraft, to maximize survivability. The FDR 122 can be implemented exclusively as a flight data recorder, but can also comprise a CVR, a Cockpit Voice and Flight Data Recorder (CVFDR), or another combination flight data and audio/video recorder, such as a QAR. The FDR 122 may be used in conjunction with a fixed wing and rotor aircraft, including, but not limited to commercial jets, military aircraft, drones, ultra-light aircraft, blimps, balloons, and flying wings. The FDR 122 can also be adapted to marine transportation systems such as boats, submarines, hovercraft, also spanning to pleasure/recreational, scientific, commercial, land-based vehicles, and space travel.

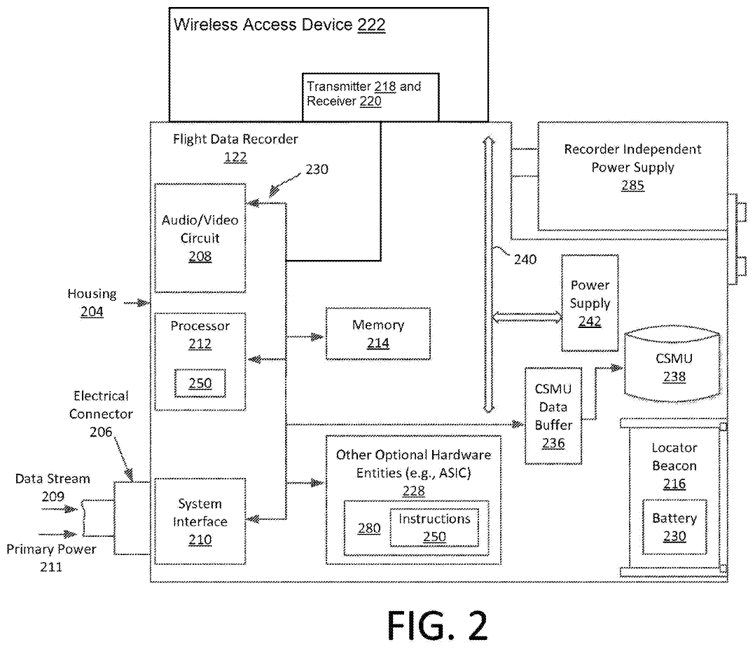

As shown in FIG. 2, the FDR 122 is comprised of a housing 204 on which an electrical connector 206 is provided. Within the housing there is provided a system interface 210, a processor 212, at least one audio/video circuit 208, a system bus 230, a storage memory (CSMU or other) data buffer, a memory device 214 connected to and accessible by other portions of the FDR 122 through system bus 230, a GPS unit 226, a locator beacon 216, and hardware entities 228 connected to system bus 230. Hardware entities 228 may include microprocessors, Application Specific Integrated Circuits (ASICs) and other hardware. At least some of the hardware entities 228 perform actions involving access to and use of memory device 214, which can be a non-volatile memory, Random Access Memory (RAM), a disk driver and/or a Compact Disc Read Only Memory (CD-ROM). System interface 210 allows the FDR 122 to communicate directly or indirectly with external devices. The CSMU data buffer 236 buffers flight data which is to be recorded. The CSMU data buffer communicates buffered flight data to a crash survivable memory unit (CSMU) 238. The FDR 122 could also be provided with a Recorder Independent Power Supply (RIPS) 285 for powering the FDR in the event of a power interruption to the FDR.

According to this example embodiment, the FDR also includes wireless access device 222 which may be separate from or embedded within the FDR. The wireless access device may include a transmitter 218 and can also include a receiver 220. According to one aspect, the wireless access device 222 can comprise a transceiver. However, this is not limiting, and the transmitter 218 and receives 220 can be selected to operate independently for purposes of effecting the necessary wireless communications described herein. The wireless access device 222 may communicate with the processor 212 and/or other hardware entities 228 via system bus 230.

As shown in FIG. 2, the hardware entities 228 can comprise a computer-readable storage medium 280 on which is stored one or more sets of instructions 250 (e.g., software code) configured to implement one or more of the methodologies, procedures, or functions described herein. The instructions 250 can also reside, completely, or at least partially, within the memory device 214, the processor 212 during execution thereof by the FDR 122. The components 214, 212, 232 also can constitute machine-readable media. The term “machine-readable media,” as used here, refers to a single medium or multiple media (e.g., a centralized or distributed database, and/or associated caches and servers) that store the one or more sets of instructions 250. The term “machine-readable media,” as used herein, also refers to any medium that is capable of storing, encoding or carrying a set of instructions 250 for execution by the FDR 122 and that cause the FDR 122 to perform any one or more of the methodologies described herein.

As shown in FIG. 2, the hardware entities 228 are embedded within the FDR. According to one or more alternate example embodiments, the hardware entities may be separate from the FDR and communicatively coupled thereto.

The FDR performs flight data recorder operations in a conventional manner. The flight data recorder operations can involve receiving a data stream 209 from a flight data acquisition unit 102. The data stream 209 includes a plurality of flight data parameters to be recorded. For example, such flight data parameters can include, but are not limited to, air speed, altitude, vertical acceleration, time, magnetic heading, control-column position, rudder-pedal position, control-wheel position, wing flap position, horizontal stabilizer, fuel flow, and landing gear position. One or more of these data elements is buffered and stored in CSMU 238. Similarly, primary electrical power 211 is provided through the electrical connector 206 or through another suitable electrical connector disposed on the FDR housing 204.

The wireless access device 222 can include any suitable type of communications equipment that is capable of carrying out the inventive arrangements described herein. For example, the wireless access device 222 can include a transmitter 218 which is configured for communicating with an earth-orbiting satellite (not shown) using a satellite communication protocol, including short burst communications. Alternately, or addition to the foregoing, the wireless access device 222 can be comprised of cellular radio equipment, WiFi (based on IEEE 802.11 standard) or WiMax (based on IEEE 802.16 standard) type or similar communication equipment, as would be understood to one of skill in the art.

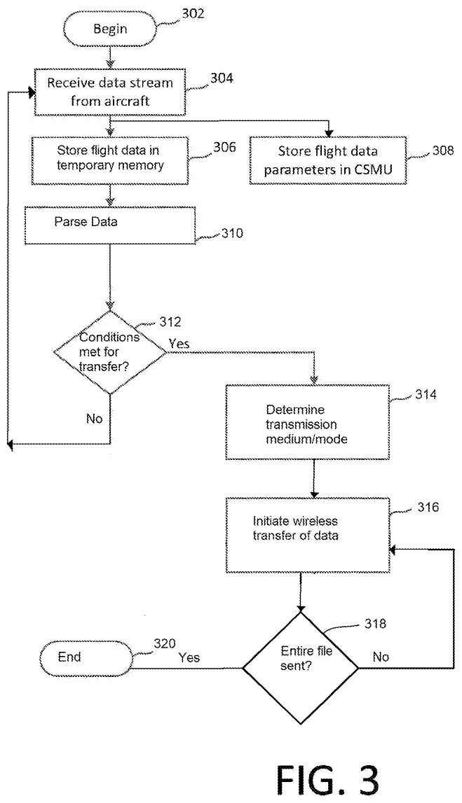

Referring now to FIG. 3, there is provided a flow diagram of an example method of autonomous, wireless transfer of data from the FDR. The method begins at 302. The FDR receives a data stream from a flight data acquisition unit on an aircraft at 304, and the FDR stores one or more flight data parameters, from the data stream, in temporary memory at 306, and also stores the flight data parameters in a CSMU at 308. Thus, the FDR has access to these stored flight data parameters which may be used to determine a timing of the wireless data transmission. At 310, the FDR parses the data stored in the temporary memory, and at 312, the FDR determines if conditions have been met for wireless transmission of the data.

At 312, the determination of whether conditions have been met for wireless transmission may include operation of an algorithm including determination of, for example, whether the aircraft has been in-air and recording flight data; whether the aircraft has landed; and whether calibrated airspeed has decreased below a predetermined speed, e.g. 100 knots. The determination of whether the aircraft has landed may be made based on whether the left- and right-main wheels have transitioned to on-ground. These determinations are made entirely autonomously by the FDR and require no crew input.

If it is determined that the conditions have been met for wireless transmission, the transmission medium and mode are determined at 314. Examples of the possible transmission media and transmission modes include, but are not limited to satellite transmission, cellular transmission, WiFi transmission, and other wireless transmission capable of meeting required transmission data rates. The determination of the appropriate transmission medium and mode is based on, but not limited to whether there has been touchdown, groundspeed, acceleration, altitude, and any of the above-described flight data parameters.

If it is determined, at 312, that the conditions have not been met, the operations may return to 304, and the FDR may continue to receive the data stream from the flight data acquisition unit.

Upon determination of the transmission medium and mode at 314, the wireless transmission of data is initiated at 316. At 318, if the entire file has been transmitted, the operation proceeds to 320 and ends. If the entire file has not been sent, for example, if the transmission has been interrupted by one or more of a variety of issues and errors, the operation returns to 316, and transmission is attempted again. Attempted retransmission need not take place consecutively within a same power cycle.

Examples of issues and errors which may cause incomplete upload include early power down of the aircraft, and interruption of wireless communication protocol.

According to an aspect of an example embodiment, operation 318 may include provision of an indication to flight or ground crew when transmission has been completed. Such indication may be, but is not limited to an LED or other visual indicator, and a record in a log file on the FDR itself or transmission by a bidirectional computer bus to the aircraft.

According to an aspect of an example embodiment, the transmission at 316 may include a transmission to an end user, for example, an analysis center, or to an intermediate destination, such as a third-party location.

As described above, and as would be understood by one of skill in the art, one or more example embodiments described herein may enable secure transfer of flight data at an earliest possible time, without any requirement of crew interaction, thus increasing the timeliness of the transmission and of analysis of the data by an analysis center. Likewise, one or more example embodiments may prevent wireless transmission of data when it is not possible, and the tracking and monitoring of data transmission when possible.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. A method of flight data transmission by a flight recorder of an aircraft, the method comprising:
receiving, from a data source, a data stream comprising flight data comprising a plurality of flight data parameters;
storing the plurality of flight data parameters in a data storage medium;
storing the plurality of flight data parameters in a temporary memory;
determining, based on a first one or more of the plurality of flight data parameters, that conditions are met for wireless transfer of the flight data;
determining, based on a second one or more of the plurality of flight data parameters, an appropriate medium and mode for transmission of the flight data; and
wirelessly transmitting the flight data using the appropriate medium and mode.

2. The method according to claim 1, wherein the flight recorder is a flight data recorder (FDR), the data source is a Flight Data Acquisition Unit, and the data storage medium is a Crash Survivable Memory Unit.

3. The method according to claim 1, wherein the plurality of flight data parameters comprise at least one of air speed, altitude, vertical acceleration, time, magnetic heading, control-column position, rudder-pedal position, control-wheel position, wing flap position, horizontal stabilizer, fuel flow, landing gear position, on-ground indication, and groundspeed.

4. The method according to claim 1, wherein the flight recorder is a flight data recorder (FDR), the data source is a Flight Data Acquisition Unit, and the data storage medium is a Crash Survivable Memory Unit.

5. The method according to claim 1, wherein the determining that conditions are met for wireless transfer comprises:
determining that the aircraft has been in flight;
the left- and right-main wheels have transitioned to on-ground; and
determining that airspeed has decreased below a predetermined speed.

6. The method according to claim 1, wherein the wirelessly transmitting comprises determining that a first wireless transmission is not completed and retransmitting the flight data using the appropriate medium and mode.

7. The method according to claim 1, wherein the appropriate medium and mode for transmission of the flight data is one of WiFi, WiMax, cellular radio transmission, and satellite transmission.

8. The method according to claim 1 further comprising, upon determining that the wireless transmission is completed, outputting an indication of completion.

9. A flight recorder system of an aircraft, the system comprising:
a housing
a system interface operatively coupled to a data source to thereby receive a data stream comprising flight data comprising a plurality of flight data parameters;
a data storage unit storing therein the one or more flight data parameters received in the flight data stream;
a wireless transmitter under exclusive control of the flight recorder system;
a non-volatile memory storing thereon computer-readable instructions;
a processor configured to execute the instructions stored on the non-volatile memory and to thereby perform a method comprising:
determining, based on a first one or more of the plurality of flight data parameters, that conditions are met for wireless transfer of the flight data;
determining, based on a second one or more of the plurality of flight data parameters, an appropriate medium and mode for transmission of the flight data;
controlling the wireless transmitter to transmit the flight data using the appropriate medium and mode.

10. The flight recorder system according to claim 9, wherein the flight recorder is a flight data recorder (FDR), the data source is a Flight Data Acquisition Unit, and the data storage medium is a Crash Survivable Memory Unit.

11. The flight recorder system according to claim 9, wherein the plurality of flight data parameters comprise at least one of air speed, altitude, vertical acceleration, time, magnetic heading, control-column position, rudder-pedal position, control-wheel position, wing flap position, horizontal stabilizer, fuel flow, landing gear position, on-ground indication, and groundspeed.

12. The flight recorder system according to claim 9, wherein the flight recorder is a flight data recorder (FDR), the data source is a Flight Data Acquisition Unit, and the data storage medium is a Crash Survivable Memory Unit

13. The flight recorder system according to claim 9, wherein the determining that conditions are met for wireless transfer comprises:
determining that the aircraft has been in flight;
the left-and right-main wheels have transitioned to on-ground; and
determining that airspeed has decreased below a predetermined speed.

14. The flight recorder system according to claim 9, wherein the controlling the wireless transmitter to transmit comprises determining that a first wireless transmission is not completed and controlling the wireless transmitter to retransmit the flight data using the appropriate medium and mode.

15. The flight recorder system according to claim 9, wherein the appropriate medium and mode for transmission of the flight data is one of WiFi, WiMax, cellular radio transmission, and satellite transmission.

16. The flight recorder system according to claim 9, wherein the processor is further configured to control output of an indication of completion, upon a determination that the wireless transmission is completed.

17. An aircraft comprising:
a flight recorder system comprising:
a housing
a system interface operatively coupled to a data source to thereby receive a data stream comprising flight data comprising a plurality of flight data parameters;
a data storage medium storing therein the one or more flight data parameters received in the flight data stream;
a wireless transmitter under exclusive control of the flight recorder system;
a non-volatile memory storing thereon computer-readable instructions;
a processor configured to execute the instructions stored on the non-volatile memory and to thereby perform a method comprising:
determining, based on a first one or more of the plurality of flight data parameters, that conditions are met for wireless transfer of the flight data;
determining, based on a second one or more of the plurality of flight data parameters, an appropriate medium and mode for transmission of the flight data;
controlling the wireless transmitter to transmit the flight data using the appropriate medium and mode.

18. The aircraft according to claim 17, wherein the flight recorder is a flight data recorder (FDR), the data source is a Flight Data Acquisition Unit, and the data storage medium is a Crash Survivable Memory Unit

19. The aircraft according to claim 17, wherein the plurality of flight data parameters comprise at least one of air speed, altitude, vertical acceleration, time, magnetic heading, control-column position, rudder-pedal position, control-wheel position, wing flap position, horizontal stabilizer, fuel flow, landing gear position, on-ground indication, and groundspeed.

20. The aircraft according to claim 17, wherein the flight recorder is a flight data recorder (FDR), the data source is a Flight Data Acquisition Unit, and the data storage medium is a Crash Survivable Memory Unit.

21. The aircraft according to claim 17, wherein the determining that conditions are met for wireless transfer comprises:
determining that the aircraft has been in flight;
the left- and right-main wheels have transitioned to on-ground; and
determining that airspeed has decreased below a predetermined speed.

22. The aircraft according to claim 17, wherein the controlling the wireless transmitter to transmit comprises determining that a first wireless transmission is not completed and controlling the wireless transmitter to retransmit the flight data using the appropriate medium and mode.

23. The aircraft according to claim 17, wherein the appropriate medium and mode for transmission of the flight data is one of WiFi, WiMax, cellular radio transmission, and satellite transmission.

24. The aircraft according to claim 17, wherein the processor is further configured to control output of an indication of completion, upon a determination that the wireless transmission is completed.

25. The aircraft according to claim 17, further comprising:
an essential electrical bus operatively coupled to the flight recorder system which can only be shut down under flight conditions when other equipment that is essential for safe flight operations is also disabled.
